(19) United States
(12) Patent Application Publication
(10) Pub. No.: US 2024/0355226 A1
(43) Pub. Date: Oct. 24, 2024

(54) RECONFIGURABLE-SURFACE DEVICE, IN PARTICULAR DISPLAY FOR DISPLAYING BRAILLE CHARACTERS

(71) Applicant: COMMISSARIAT A L'ENERGIE ATOMIQUE ET AUX ENERGIES ALTERNATIVES, Paris (FR)

(72) Inventors: Charles HUDIN, GIF SUR YVETTE CEDEX (FR); Moustapha HAFEZ, GIF SUR YVETTE CEDEX (FR); Nicolas HEHN, Niederhergheim (FR); Sabrina PANËELS, GIF SUR YVETTE CEDEX (FR)

(21) Appl. No.: 18/691,362

(22) PCT Filed: Sep. 12, 2022
(86) PCT No.: PCT/FR2022/051709

§ 371 Date: Mar. 12, 2024

(30) Foreign Application Priority Data
Sep. 13, 2021 (FR) FR2109555

(51) Int. Cl. G09B 21/00

(52) U.S. Cl. CPC G09B 21/004

(57) ABSTRACT

Tactile display including a display surface equipped with holes, a waveguide plate, equipped with holes, pins, each pin being slidably mounted in a hole of the display surface and a hole-of the waveguide plate in a direction between a first position and a second position, actuators fastened to the waveguide plate triggering an out-of-plane displacement of the waveguide plate, and a control unit controlling the actuators according to the time-reversal wave focusing method, in such a way that the actuators generate a wave in the waveguide plate located at the pin(s) to be activated, which generates a pulse in the waveguide plate and triggers the displacement of the pin(s) which switch(es) from the first position to the second position, a holder for holding the pin in each of the positions.

### TECHNICAL FIELD AND PRIOR ART

The present invention relates to a reconfigurable-surface device, in particular a tactile display, in particular for displaying Braille characters, having a reduced size.

It is sought to produce tactile displays capable of displaying Braille characters, this type of display is referred to as “Braille deck” or “Braille display”.

Visually-impaired people can read text that has been translated into the Braille alphabet, in which each character is represented in a six-dot matrix in two columns, with each character formed by one to six raised dots. Access to digital content using the Braille alphabet requires the use of a Braille display which is a heavy, bulky, fragile and expensive object.

Each Braille character is represented by a Braille cell capable of including 1 to 6 dots.

A Braille display consists of several hundred pins of around 1.5 mm in diameter and spaced approximately 2.5 mm apart. The typical height of a Braille dot is around 0.5 mm. The holding force of a pin is around 0.15 N.

Each dot must be capable of being actuated independently.

An example of a display suitable for use as a Braille display is described in the document by J. J. Zarate and H. Shea, “Using pot-magnets to enable stable and scalable electromagnetic tactile displays”, IEEE Transactions on Haptics, 2016, pp. 1-8. This display includes pins slidably mounted through a plate. Each pin includes a magnet and an actuator formed by an electromagnetic coil is disposed under the pin. The direction of the current circulating in the coil determines the upward or downward displacement of the pin. This display requires one actuator per pin. Therefore, the size is substantial. Furthermore, the space available between the pins is limited on account of the relative position of the pins required in the case of a Braille display. Furthermore, the electric current required to activate a pin is relatively substantial, around 0.7 A, which limits the number of pins that can be actuated simultaneously. The current required may be reduced by increasing the size of the magnets, which reduces the actuator and therefore pin density. Furthermore, holding in position required a continuous electrical power supply of the coils, which is very energy-intensive. It is proposed to add locking devices but they are not described, and in any case, adding such devices would be cumbersome, complex to implement and would increase the time to switch the pin from one state to another.

### DISCLOSURE OF THE INVENTION

Consequently, one aim of the present invention is that of providing a reconfigurable-surface device not having the above drawbacks.

The aim stated above is achieved by a reconfigurable-surface device including at least one pin slidably mounted through a plate, said pin being capable of adopting at least two positions, and at least one actuator to switch the pin at least from one position to the other, means for holding each pin in one of its positions, a plate forming a waveguide interacting with said pin, and a control unit configured to control said at least one actuator using the time-reversal wave focusing method, such that it generates a wave in the waveguide located at the pin, which triggers the appearance of an out-of-plane pulse in the waveguide and the displacement of said pin in such a way as to switch from one position to the other.

Thus, the actuator may be distant from the pin, in particular it is no longer necessary for it to be aligned with it in the vertical direction as is the case in prior art devices.

Advantageously, the holding means are bistable, which makes it possible not to require energy to hold the pin in either of the positions.

In an embodiment, the bistable holding means are of magnetic type, the energy supplied by the actuator is sufficient to switch the pin from one stable position to the other.

For example, each pin carries a magnet.

In a further embodiment, the bistable holding means are mechanical.

In a further embodiment, the holding means are electrostatic type.

In other words, the inventors considered associating the time reversal principle and a system for holding in position, the wave generated by time reversal is focused at one or more zones forming a source of mechanical energy giving the change-of-state pulse and the change of state is assisted and confirmed by the holding means.

The present invention is especially advantageous when several pins and several actuators are implemented. On one hand, the actuators may be disposed at a distance from the pins, for example they may be disposed on the edge of the waveguide. On the other, a number of actuators less than the number of pins is advantageously used. This, the size of the actuation means are reduced in relation to prior art devices.

Furthermore, the pins are activated remotely and several pins may be activated simultaneously.

Particularly advantageously, the reconfigurable-surface device forms a tactile display, in particular a Braille character display.

The present application then relates to a reconfigurable-surface display including a reconfigurable surface equipped with m holes, m being a positive integer at least equal to 1, a plate forming a waveguide, referred to as waveguide plate, m pins, each pin being slidably mounted in a hole of the reconfigurable surface in an orthogonal direction to the waveguide plate, and capable of adopting a first stable position and a second stable position, at least in the second position, one end of the pin protruding from the reconfigurable surface, at least one actuator fastened to the waveguide plate capable of triggering an out-of-plane displacement of the waveguide plate, and a control unit configured to control said at least one actuator according to the time-reversal wave focusing method, in such a way that said actuator generates a wave in the waveguide plate located at the at least one pin, which generates a pulse in the waveguide plate and triggers the displacement of said pin so as to switch it at least from the first position to the second position, and means for holding said pin at least in the second position.

In an advantageous example, the holding means are bistable holding means configured so that said pulse triggers the switch from one stable state to the other stable state.

For example, the bistable holding means are such that they exert a return force holding the pin in the first position and a return force holding the pin in the second position.

Advantageously, the waveguide plate is equipped with m holes, each hole of the waveguide plate being aligned with a hole of the reconfigurable surface, each pin being slidably mounted in a hole of the reconfigurable surface and a hole of the waveguide plate.

In an embodiment example, the pin includes a first shoulder configured to bear against the waveguide plate in the first position and a second shoulder configured to bear against the waveguide plate in the second position.

In a further embodiment example, the bistable holding means include either at least a magnet rigidly connected to the pin and a waveguide plate made of ferromagnetic material, or at least a magnet rigidly connected to the waveguide plate and an element made of ferromagnetic material rigidly connected to the pin.

The first and second shoulders may be borne by permanent magnets and the waveguide plate is made of ferromagnetic material. Alternatively, the first and second shoulders are borne by elements made of ferromagnetic material and the waveguide plate bears permanent magnets or is a permanent magnet.

The bistable holding means are mechanical.

Alternatively, the holding means are electrostatic, at least the second shoulder forming an electrode and the plate bearing the reconfigurable surface forms an electrode.

According to an additional feature, said at least one actuator is capable of generating bending waves or Lamb waves in the waveguide plate.

Advantageously, the reconfigurable-surface device includes several actuators distributed on the edges of the waveguide plate.

The present application further relates to a tactile display including a reconfigurable-surface device according to the invention, wherein the reconfigurable surface is a tactile display surface and the device includes a plurality of pins.

Very advantageously, the pins, when they are in their second position, do not protrude from the display surface, said display forming a Braille display.

The present application further relates to a tactile display method on a tactile display according to the invention, including several pins, said method including:
selecting pins to switch from the first position to the second position or vice versa, based on a digital content to be displayed,
sending at least one order to said at least one actuator to change the position of the selected pins,
generating by the at least one actuator waves focused in the waveguide plate at the selected pins, said focusing being obtained with the time-reversal focusing method.

### BRIEF DESCRIPTION OF THE DRAWINGS

The present invention will be better understood based on the following description and the appended drawings wherein:

FIG. 1 is a schematic representation of a longitudinal sectional view of an embodiment example of a reconfigurable-surface device according to a first embodiment,

FIG. 2 is a top view of a waveguide plate equipped with actuators capable of being implemented in the present invention,

FIG. 3A is a graphic representation of the potential energy in mJ of a pin of the device of FIG. 1 according to its position in the direction Z,

FIG. 3B is a graphic representation of the return force in N applied to a pin of the device of FIG. 1 according to its position in the direction Z,

FIG. 4 is a schematic representation of a longitudinal sectional view of a further embodiment example of a tactile display according to the first embodiment,

FIG. 5 is a schematic representation of a longitudinal sectional view of a further embodiment example of a reconfigurable-surface device according to the first embodiment,

FIG. 6 is a schematic representation of a longitudinal sectional view of a further embodiment example of a reconfigurable-surface device according to the first embodiment,

FIG. 7 is a schematic representation of a longitudinal sectional view of a further embodiment example of a reconfigurable-surface device according to the first embodiment,

FIG. 8 is a schematic representation of a longitudinal sectional view of a further embodiment example of a reconfigurable-surface device according to the first embodiment,

FIG. 9 is a schematic representation of a longitudinal sectional view of a further embodiment example of a reconfigurable-surface device according to the first embodiment,

FIG. 10 is a schematic representation of a longitudinal sectional view of an embodiment example of a reconfigurable-surface device according to a second embodiment,

FIG. 11A is a schematic representation of a longitudinal sectional view of an embodiment example of a reconfigurable-surface device according to a third embodiment,

FIG. 11B is a schematic representation of a variant of the device of FIG. 11A,

FIG. 12 is a transcription of the letter d in Braille,

FIG. 13 is a schematic illustration of a longitudinal sectional view of a variant of the device of FIG. 1.

### DETAILED DISCLOSURE OF PARTICULAR EMBODIMENTS

The following description will focus more specifically on a tactile display in particular a tactile display forming a Braille display, but the present application relates more generally to a reconfigurable-surface device as described hereinafter.

Moreover, the tactile display according to the invention may be used to display images or any other content tactilely.

In FIG. 1, a partial sectional view of a tactile display according to an example of a first embodiment can be seen.

The display includes a display surface 2 or reading surface borne by a plate 4. In the example shown, the display has a rectangular shape, but this shape is not restrictive and any other shape such as circular or oval, or any other shape is not outside the scope of the present invention.

The plate 4 includes a plurality of holes 6 normal to the plate 4. The display includes pins 8, each pin 8 being slidably mounted in a hole 6 along a direction Z normal to the plate 4.

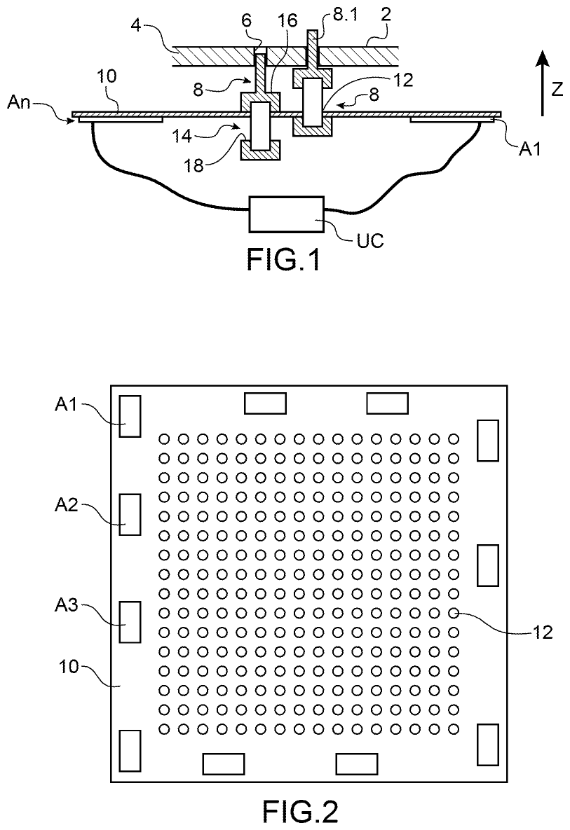

The display also includes a waveguide (FIG. 2) formed by a plate 10 made of ferromagnetic material perforated with the same number of holes 12 as holes 6, each hole 12 being aligned with a hole 6 in the direction Z. Each pin 8 is slidably mounted both in a hole 6 and in a hole 12.

In this example, each pin 8 is configured to adopt two stable positions, a first position or low position, wherein the pin does not protrude from the reading surface, and a second position or high position, wherein the pin protrudes from the reading surface.

The plate 10 has in the example shown and preferably the same outer dimensions as the plate 4.

The display includes at least one actuator A1, preferably several actuators A1, A2, A3 . . . An fastened to the waveguide. In the example shown and advantageously, the actuators are fastened along the edges of the waveguide plate, which makes it possible to leave the entire central zone free for the pins. Preferably, the actuators are not disposed on the axes of the symmetry of the waveguide plate which is favourable for obtaining precise wave focusing. The actuators may be piezoelectric actuators, for example made of piezoelectric ceramic. Alternatively, the actuators are electromagnetic.

The actuators are such that they are capable of generating waves triggering an out-of-plane displacement of the waveguide, typically it consists of bending waves or Lamb waves, for example A0 Lamb mode.

The display also includes a control unit UC configured to control the actuators in such a way that they focus the waves generated at given dots by the time-reversal focusing method, the principle of which is described in the document C. Hudin, J. Lozada, and V. Hayward, ‘Localized Tactile Feedback on a Transparent Surface through Time-Reversal Wave Focusing’, IEEE Transactions on Haptics, vol. 8, no. 2, pp. 188-198, April 2015. The control unit is connected to the actuator for example by electric wires.

To focus the wave under a pin and generate the impact, each actuator is driven with a signal corresponding to the impulse response between this actuator and the focal point.

We will briefly describe the principle of time-reversal focusing.

The principle of wave time reversal is based on the invariance of the time-reversal wave propagation equation and on the reciprocity principle.

Let:

$$h ( {x}_{a} \vert {x}_{q} , {y}_{a} \vert {y}_{q} , t )$$

be the impulse response over time t at a dot of coordinates (xₐ, yₐ) after an impulse signal has been emitted by an actuator at (x_{q}, y_{q}).

Considering that the response of the plate and actuator system is linear, if the actuator located at q emits no longer a pulse but a signal S_{q}(t), the displacement at the dot a is then given by:

$$u ( {x}_{a} , {y}_{a} , t ) = h ( {x}_{a} \vert {x}_{q} , {y}_{a} \vert {y}_{q} , t ) ⊗ {s}_{q} ( t )$$

where ⊗ is the convolution operator.

Thus, if the actuator located at q emits, no longer a pulse, but the time-reversed impulse response from the time T to the initial time t=0, which is a signal proportional to this response, namely:

$${s}_{q} ( t ) = K h ( {x}_{a} \vert {x}_{q} , {y}_{a} \vert {y}_{q} , T - t )$$

Where K is an amplification gain and where 0<t<T,

the displacement produced at any dot b will be:

$$u ( {x}_{b} , {y}_{b} , t ) = h ( {x}_{b} \vert {x}_{q} , {y}_{b} \vert {y}_{q} , t ) ⊗ {s}_{q} ( t ) = h ( {x}_{b} \vert {x}_{q} , {y}_{b} \vert {y}_{q} , t ) ⊗ Kh ( {x}_{a} \vert {x}_{q} , {y}_{a} \vert {y}_{q} , T - t ) = K {\int }_{0}^{t} h ( {x}_{b} \vert {x}_{q} , {y}_{b} \vert {y}_{q} , t - ζ ) h ( {x}_{a} \vert {x}_{q} , {y}_{a} \vert {y}_{q} , T - ζ ) dζ$$

The displacement is thus the result of the integral of the product of two functions which are a priori not correlated, the result of which is therefore zero average. There is at any dot b and time t a zero average displacement which represents a background variation present on the whole plate. On the other hand, at the time t=T corresponding to the end of the emission phase by the actuator, the following displacement is obtained at the dot a:

$$u ( {x}_{a} , {y}_{a} , t ) = K {\int }_{0}^{t} {h}^{2} ( {x}_{a} \vert {x}_{q} , {y}_{a} \vert {y}_{q} , T - ζ ) dζ$$

A strictly positive quantity is integrated this time. The result is a large-amplitude non-zero displacement. This displacement is obtained only at the dot a and at the time T, hence the focusing of the waves spatially and over time.

In the case where Q actuators are used, their contributions are added to give:

$$ι ι ( x , y , t ) = {\sum }_{q = 1}^{Q} {u}_{q} ( x , y , t )$$

The contrast is defined as the ratio between the displacement at the focal point at the time T and the standard deviation of this displacement at any dot b. It is obtained with the equation:

$$C = \sqrt{{BT}_{c}} \sqrt{\frac{Q τ ( 1 - {e}^{- 2 T / τ} )}{( Q + 1 ) τ ( 1 - {e}^{- \frac{2 T}{τ}} ) + {T}_{c}}}$$

Where Q is the number of actuators, T the duration of the reversal window, τ the attenuation time constant of vibrations in the plate and T_{c} the characteristic time of the plate or modal density of the plate in seconds, or fundamental mode per Hz and B=fₘₐₓ−fₘᵢₙ the bandwidth, in Hertz, of the signals emitted by the actuators.

As soon as the focusing is repeated over time with a period Tᵣ, the contrast is assigned according to the equation:

$$\hat{C} = C \sqrt{1 - {e}^{- 2 {T}_{r} / τ}}$$

To preserve the contrast, successive focuses are repeated with a period Tᵣ≥τ.

The mean frequency of the signals defines the maximum resolution achievable by the equation:

$${R}_{B} = \sqrt[4]{\frac{D}{{ρ}_{s}}} \sqrt{\frac{8}{2 π {f}_{m}}}$$

Where Rₛ is the spatial resolution, or half-height width of the focal point,

$${f}_{m} = \frac{{f}_{max} + {f}_{min}}{2}$$

the mean frequency of the signals emitted, D the flexural rigidity and pₛ the mass per unit of surface area of the plate. The impulse responses h(t) may be obtained either experimentally by actually recording the impulse responses, or by simulation, or analytically when the geometry remains simple.

A database is then produced of the reversed impulse responses at different dots or zones of the surface located under the pins by calibration, this database is used to generate the signals sent to the actuators. It may be envisaged not to produce a database of the dots under all the pins, and to determine the impulse responses between the dots of the database, for example by interpolation, which makes it possible to reduce the time to produce the database and its size.

To switch a pin from its low state to its high state, the impact generated by the waveguide on the pin 8 is directed upwards. To switch it from its high state to its low state, the impact is directed downwards. This change of direction is obtained for example by multiplying the drive signal of the actuators by a factor −1.

Similarly, to actuate several pins simultaneously, the impulse responses corresponding to each pin may be added and the actuators driven with this sum. A focusing at several dots is then obtained, optionally in different directions according to the sought switching.

The amplitude of the pulse under each pin is dependent on the effective drive voltage and the number of pins simultaneously actuated. A high power makes it possible to switch several pins simultaneously.

The focus spot may be larger than the cross-section of a pin, but the maximum displacement velocity of the waveguide plate is located under the pin to be activated, only this pin will be activated. The velocity of the waveguide plate outside the zone of the maximum velocity decreases rapidly. For a spatial resolution equal to twice the distance between two pins. the pins adjacent to the pin to be activated have a velocity of the order of 50% of the pin velocity to be activated. They are then not activated.

To maximise focusing quality, the waveguide plate may be such that it promotes the chaotic nature of the wave propagation in the plate by giving it a complex geometry associating rectilinear edges and curved edges, avoiding axes of symmetry and holding the plate in an inhomogeneous manner.

Thus, all or some of the actuators A1, . . . An are controlled to focus the waves that they generate in the waveguide at the holes 12 wherein the pins are mounted. The actuators can focus their waves at one or more dots of the waveguide.

The control unit generates its orders to the actuators on the basis of a digital content to be displayed, for example a page of a book. It converts this content into pins to be actuated and at locations of pulses to be generated in the waveguide plate.

The pins 8 are configured to be sensitive to localised out-of-plane movements triggered by actuator control.

The pins 8 are all of similar structure, a single pin will be described in detail.

The pin 8 includes a cylinder of revolution-shaped permanent magnet 14 of diameter such that it slides in the hole 12 and is guided thereby. The axis of the magnet is oriented in the direction Z. The poles of the magnet are located at the longitudinal ends of the magnet.

The pin 8 also includes a first shoulder 16 and a second shoulder 18, the shoulders 16, 18 being located at either end of the waveguide plate 10. The first shoulder 16 is oriented in such a way that it bears against a first face of the waveguide facing the plate 4 when the pin is in its first position. The second shoulder 18 is oriented in such a way that it bears against a second face of the waveguide opposite the first face, when the pin is in its second position.

Furthermore, the pin 8 includes an end 8.1 intended to protrude from the reading surface.

In the example shown, the hole 6 has a diameter less than that of the hole 12, the diameter of the end 8.1 is less than that of the magnet. Alternatively, the end 8.1 of the pin and the magnet have the same diameter.

In this example, the first shoulder 16 and the second shoulder 18 are mounted on the longitudinal ends of the magnet.

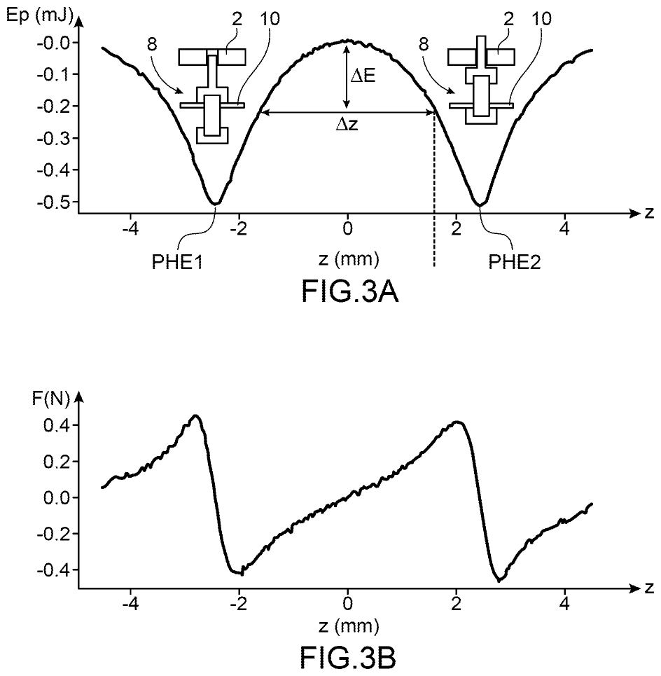

The operation of the display of FIG. 1 will now be described with reference to FIGS. 3A and 3B.

The cooperation of the magnet 14 and the ferromagnetic waveguide plate 10 generates a return force between the pin 8 and the ferromagnetic plate 10 such that, either the pin 8 is pushed downwards to its first stable position, the first shoulder 16 bearing against the first face of the waveguide 10, or the pin 8 is pushed upwards to its second stable position, the second shoulder 18 bearing against the second face of the waveguide 10. In FIG. 3A, the potential energy Ep in mJ of a pin 8 according to its position in mm along the direction Z can be seen, the positive direction goes from the bottom to the top. The position z=0 corresponds to the position wherein the half-height of the magnet coincides with the median plane of the waveguide plate, which is a local maximum and an unstable equilibrium point. It is noted that the potential energy includes two sinks at the positions −2.5 mm and +2.5 mm approximately, which correspond to the theoretical stable positions of the pin.

Δz corresponds to the displacement along Z of the pin between the low and high positions.

Preferably, the positions of the first and second shoulders are out-of-equilibrium positions PHE1, PHE2 such that the return force exerted by the magnet on the pin presses the first shoulder 16 or the second shoulder 18 onto the first face or the second face of the waveguide 10 respectively. Furthermore, the energy required to switch from one state to the other named ΔE in FIG. 3A is hence lower. In FIG. 3B, the return force F in N generated by the magnet according to the position of the magnet along the direction Z in mm can be seen represented.

Outside the transition phases, the first shoulder 16 or the second shoulder 18 is pressed against the first or the second face of the waveguide 10 respectively.

In this example, in the low position, the pin 8 is at a position z of approximately −1.7 mm and the magnet exerts a return force of approximately −3.2 N. In the high position, the pin 8 is at a position z of approximately 1.7 mm and the magnet exerts a return force of approximately 3.2 N.

Switching from one stable position to the other is obtained by the kinetic energy supplied by the pulse of the out-of-plane deformation of the waves focused in the waveguide under the pin concerned.

The kinetic energy transmitted is determined in such a way to be greater than the potential barrier ΔE between the two positions of the pin.

The kinetic energy of the pin is written

$${E}_{c} = \frac{1}{2} M {V}^{2}$$

where M is its mass and V its velocity. It is therefore possible to define a release velocity

$$\vert V \vert = \sqrt{\frac{2 Δ E}{M}}$$

from which the pin acquires enough energy to switch from one state to the other.

The control unit UC controls the actuators in such a way as to focus the waves on one or more zones of the waveguide located under the pins.

Furthermore, the control unit UC controls the actuators in such a way that they generate an upward or downward pulse to switch the pin from a high position to a low position and vice versa.

For example, it is sought to display the letter “d” tactilely.

In FIG. 12, the transcription of d in Braille can be seen. Each dot includes a number from 1 to 6.

The control unit UC controls the actuators in such a way that they generate upward pulses under the pins 1, 4 and 5 in such a way as to switch only these pin to the high position, the pins 2, 3, 6, remaining in the low position.

When another character is to be displayed instead of d, preferably the control unit UC controls the actuators so that they generate downward pulses under the pins 1, 4 and 5 so that they switch to the low position. All the pins are in the low position. Then, pulses are generated under the pins to be switched to the high position.

The cooperation of the magnet and the ferromagnetic plate forms bistable holding means which hold in position with energy input, which is particularly suitable for a portable tactile display.

Furthermore, the invention allows a refresh rate compatible with the Braille display. Indeed, the focusing time is of the order to a few milliseconds.

For a Braille display, the bistable system is for example dimensioned to obtain an extrusion Δz of the pin between approximately 0.5 mm and approximately 1 mm and a holding force of the order of 0.15 N.

According to Braille writing standards, the centre distance between two adjacent dots is of the order of 2.7 mm, the distance between the axes of two pins is then selected of the order of 2.7 mm. Thanks to the invention, as the actuators are not under each pin, such a relative arrangement of the pins is readily achievable.

The present invention may be applied to the display of other elements, for example contours or images, in this case, the distances between pins may be more or less great. It may be envisaged to produce a tactile display including pins in which the centre distance is 1.3 mm. When the images are displayed, all or some of the pins may be activated and when the characters are to be displayed, one pin in two is activated to meet Braille writing display standards.

Actuation by time-reversal focusing makes it possible to actuate the sought pin(s) without assigning the others. Thus, in the case of Braille writing, each of the six pins of a character may be activated independently without risking activating a neighbouring pin in error.

Thanks to the invention, any pin may be activated remotely using a reduced set of actuators. The number of actuators is independent of the number of dots of the pin matrix, this number is nonetheless linked with the power required for actuating a pin and the sought refresh rate. It may be envisaged to produce a device with a single actuator and several pins.

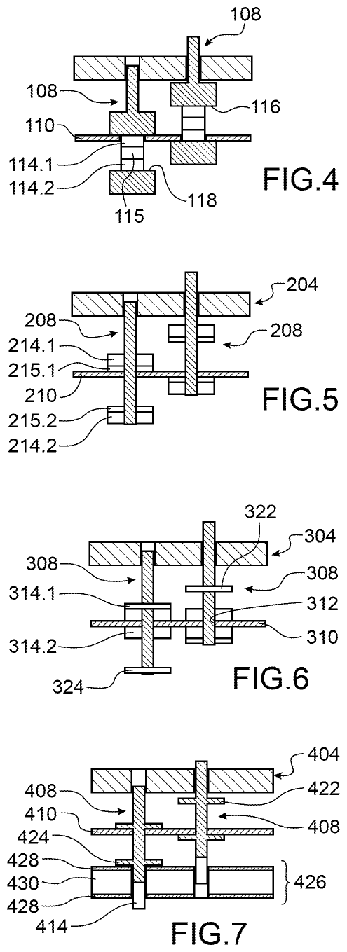

In FIGS. 4 to 11, different displays including at least two pins can be seen represented, one of the pins being in the low position and the other pin being in the high position.

In FIG. 4, a further example of a tactile display according to the first embodiment can be seen.

In this example, the single permanent magnet 14 of each pin 108 is replaced by two magnets 114.1, 114.2 separated by an element made of non-magnetic material 115. The magnet 114.1 is in contact with the first shoulder 116, the magnet 114.2 is in contact with the second shoulder 118. The mass of the pins is thus reduced, which lowers the activation energy in relation to the display of FIG. 1. The operation is similar to that of the display of FIG. 1. The return force is exerted either mainly between the magnet 114.1 and the waveguide plate 110, or mainly between the magnet 114.2 and the waveguide plate 110.

In FIG. 5, a further example of a display according to the first embodiment can be seen, wherein the pins 208.1, 208.2 each include two magnets, 214.1, 214.2, one 214.1 being disposed between the ferromagnetic waveguide 210 and the plate bearing the reading surface 204, the other 214.2 being located on the other side of the waveguide plate 210. The magnets are for example ring-shaped. In the example shown, blocks 215.1, 215.2 made of non-magnetic material are in contact with the face of each magnet oriented towards a face of the waveguide plate 210, which makes it possible to reduce the force of attraction between each magnet and the ferromagnetic plate. A pin without a block or with only one block is not outside the scope of the present application.

In FIG. 6, a further example of a display according to the first embodiment can be seen, wherein the permanent magnets are fastened to the waveguide plate 310. Each pin 308 includes a rod 320 slidably mounted in the waveguide plate and in the plate 304. Each rod includes transversal extensions 322, 324 bearing the first and second shoulders. The transversal extensions are made of ferromagnetic material.

The waveguide plate 310 bears for each pin 308 magnets 314.1, 314.2 mounted for one on one face of the plate and for the other on the other face of the plate and surrounding the passage 312 respectively. The magnets are ring-shaped. In the low position, the transversal extension 322 bears against the magnet 314.1 and in the high position the transversal extension 324 bears against the magnet 314.2.

In this example, the waveguide plate may be made of a different material from a ferromagnetic material.

The operation of the display of FIG. 6 is similar to that of the display of FIG. 1, but the return forces are generated between the magnets and the transversal extensions made of ferromagnetic material.

In FIG. 7, a further embodiment example of a tactile display according to the first embodiment can be seen.

In this example, the magnet 414 is borne by the pin 408 and is located at the longitudinal end of the pin located opposite the end intended to protrude from the reading surface. Furthermore, the display includes, in addition to the plate bearing the reading surface and the waveguide plate 410, a ferromagnetic structure 426 parallel with the waveguide plate and located opposite the plate 404 in relation to the waveguide plate 410.

The ferromagnetic structure 426 includes two ferromagnetic plates 428 separated by a non-magnetic material 430. The structure includes holes 432 aligned with the holes 412 of the waveguide plate 410 and in each of which the end of a pin including the magnet is slidably mounted.

Each pin includes two transversal extensions 422, 424.

For each pin, the magnet 414 tends to be aligned on either of the ferromagnetic plates 428 and to exert a return force. In FIG. 7, the pin 408 is in the low position, the magnet 414 is aligned with the bottom plate 428, and the transversal extension 422 is pressed against the first face of the waveguide plate 410. When a pulse is given to the pin 408 by the waveguide plate via the transversal extension 422, the pin 408 is displaced upwards, the magnet is attracted by the ferromagnetic plate 428, the pin 408 switches to the high position (position of the pin to the right in FIG. 7).

In this example, preferably, the waveguide plate is made of a different material from a ferromagnetic material.

It is to be noted that interactions may arise between the magnets which may create instabilities and complicate the control of each of the pins. Advantageously, as shown in FIG. 13, which is a variant of the display of FIG. 1, magnetic shields B are used to limit these interactions. In this example, each shield has a ferromagnetic strip shape partitioning the magnets without touching the waveguide plate. These shields serve to channel the magnetic flux from the magnets so as to limit the interferences between them.

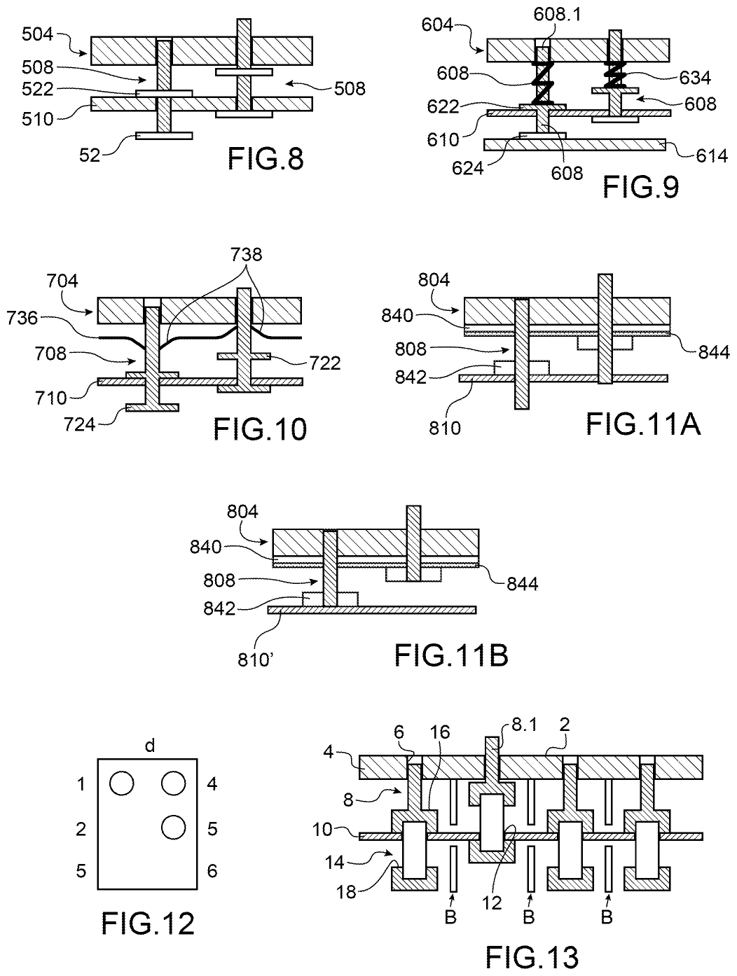

In FIG. 8, a further embodiment example of a tactile display according to the first embodiment reducing the interactions between the magnets can be seen.

In this example, the entire waveguide 510 is made of a material forming a permanent magnet, the magnetisation being oriented in the direction Z. This example is similar to that of FIG. 6, wherein the magnets were mounted on the waveguide plate. This embodiment example has the advantage of suppressing the interactions between the magnets of the different bistable means.

The operation of this display is similar to that of FIG. 1.

It is noted that the transversal extension 522 of the pin 508 does not come to a stop against the plate 504 in the high position, the stop is provided solely by the transversal extension 524. Alternatively, the transversal extensions 522 and 524 simultaneously come into contact with the plate 504 and the permanent magnet respectively, this nonetheless requires thorough adjustment.

In FIG. 9, a further embodiment example of the tactile display combining both a magnetic return force and a mechanical return force can be seen.

In this example, the permanent magnet 614 is formed by a separate plate from the waveguide 610 and is disposed opposite the plate 604 in relation to the waveguide.

The pins 608 include a transversal extension 624 at the longitudinal end 608.2 opposite the longitudinal end 608.1 intended to protrude from the display surface. The transversal surface 624 is made of ferromagnetic material, in such a way as to exert a downward return force. The transversal extension 622 forming the first shoulder is made of non-magnetic material, which does not generate a return force between this shoulder and the magnet, pressing the transversal extension 622 against the top face of the waveguide plate 610. A mechanical return means 634, such as a helical spring, is mounted between the plate 604 and the transversal extension 622 exerting an upward return force, pressing the transversal extension 624 against the bottom face of the waveguide plate 610. The spring is dimensioned to exert a similar return force to that exerted between a transversal extension made of ferromagnetic material and the magnet.

In FIG. 10, a further embodiment example of a display according to a second embodiment can be seen, wherein the bistable holding is obtained by mechanical means.

The display includes pins 708 each having first and second shoulders borne by transversal extensions 722, 724, a waveguide plate 710 and a plate 704 bearing the reading surface. The pins pass through the waveguide, the two transversal extensions 722, 724 being located on either side of the waveguide plate 710, the pins also pass through the plate 704.

Furthermore, the display includes bistable holding means including a membrane 736 disposed between the waveguide plate 710 and the plate 704 and passed through by the pins 708. The membrane is not interposed between the first shoulder and the waveguide plate. The pins are rigidly connected in movement to the membrane.

The membrane includes zones configured to have two stable states. The membrane may consist of a plurality of curved elements 738 having two stable states of foil type. Such elements 738 are described in the document A. Asher, E. Benjamin, L. Medina, R. Gilat, and S. Krylov, “Bistable Micro Caps Fabricated by Sheet Metal Forming”, J. Micromech. Microeng., vol. 30, no. 6, p. 065002, April 2020. A rigid plate perforated with holes each sealed by a bistable disk may be envisaged, said disk being passed through by a pin.

The pulse or impact supplied by the waveguide 710 triggers the switch from a state having one curvature to another state having an opposite curvature.

In FIG. 10, two elements 738 in two opposite states can be seen.

In FIG. 11A, a further embodiment example of a tactile display according to a third embodiment can be seen, wherein the holding means are electrostatic type.

The display includes a single electrode 840 fastened under the plate 804 and individual electrodes 842 fastened to each of the pins and also forming the first shoulder and the second shoulder. An electrical insulating layer 844 covers the electrode 840 to prevent a short-circuit between the electrode 840 and one or more electrodes 842.

The operation of the display of FIG. 11A is as follows.

A first potential is applied to the electrode 840.

The electrode 842 of the pin 808 to be moved is set to a second potential. A mechanical pulse is exerted by the waveguide plate 810 on the pin 808 via the electrode 842 triggering the upward displacement of the pin, the displacement of which is assisted by the electrostatic attraction force between the electrode 840 and the electrode 842. The electrode 842 comes into contact with the insulating layer 844 and the pin is held in the high position by electrostatic attraction.

Each electrode 842 may be polarised separately, which enables individual actuation of the pins.

When the electrodes 840 and 842 are at the same potential, the electrostatic attraction disappears and the pin returns to the low position by gravity.

Alternatively, the electrode 840 may be replaced by individual electrodes.

In this example, holding in the high position requires an electrical power supply.

In FIG. 11B, an alternative embodiment of the display of FIG. 11A may be seen, wherein the waveguide plate 810′ has no holes, the electrode 842 resting on the waveguide. Each pin is then only guided in translation by the hole in the plate 804. Indeed, the return to the low position being obtained by gravity, no pulse is to be transmitted by the waveguide to the pin by cooperation between a shoulder and the bottom face of the waveguide.

The time-reversal focusing method is particularly effective when the propagation medium is complex, which is the case in the embodiments of FIGS. 1 to 11A, wherein the waveguide plate is perforated and loaded with pins which diffract the waves.

In the examples described, the low position of the pins corresponds to a fully retracted position of the pins, i.e. not protruding from the reading surface. It will be understood that a pin which protrudes from the display surface regardless of its position does not fall outside the scope of the present invention. Moreover, the different pins may protrude from the reading surface with different heights.

Furthermore, the device according to the invention may be used to display tactile images and not only characters in Braille writing.

The device may for example replace a paper publication in Braille writing. One page is displayed at a time on the display and at each page change, the display is modified.

The reconfigurable-surface device according to the invention may also be used to move objects, for example a spherical object. For this, the pins are activated successively to rotate the spherical element along a given path. The pins may have different heights, some serving to guide the object and other to move it. The control unit is then configured to move the object along a given trajectory.

What is claimed is:

1. Reconfigurable-surface display including a reconfigurable surface equipped with m holes, m being a positive integer at least equal to 1, a plate forming a waveguide, referred to as waveguide plate, m pins, each pin being slidably mounted in a hole of the reconfigurable surface in an orthogonal direction to the waveguide plate, and capable of adopting a first stable position and a second stable position, at least in the second position, one end of the pin protruding from the reconfigurable surface, at least one actuator fastened to the waveguide plate capable of triggering an out-of-plane displacement of the waveguide plate, and a control unit configured to control said at least one actuator according to the time-reversal wave focusing method, in such a way that said actuator generates a wave in the waveguide plate located at the at least one pin, which generates a pulse in the waveguide plate and triggers the displacement of said pin so as to switch it at least from the first position to the second position, and means for holding said pin at least in the second position.

2. Reconfigurable-surface device according to claim 1, wherein the holding means are bistable holding means configured so that said pulse triggers the switch from one stable state to the other stable state.

3. Reconfigurable-surface device according to claim 2, wherein the bistable holding means are such that they exert a return force holding the pin in the first position and a return force holding the pin in the second position.

4. Reconfigurable-surface device according to claim 1, wherein the waveguide plate is equipped with m holes, each hole of the waveguide plate being aligned with a hole of the reconfigurable surface, each pin being slidably mounted in a hole of the reconfigurable surface and a hole of the waveguide plate.

5. Reconfigurable-surface device according to claim 4, wherein the pin includes a first shoulder configured to bear against the waveguide plate in the first position and a second shoulder configured to bear against the waveguide plate in the second position.

6. Reconfigurable-surface device according to claim 3, wherein the bistable holding means include either at least a magnet rigidly connected to the pin and a waveguide plate made of ferromagnetic material, or at least a magnet rigidly connected to the waveguide plate and an element made of ferromagnetic material rigidly connected to the pin.

7. Reconfigurable-surface device according to claim 5, wherein the first and second shoulders are borne by permanent magnets and the waveguide plate is made of ferromagnetic material.

8. Reconfigurable-surface device according to claim 5, wherein the first and second shoulders are borne by elements made of ferromagnetic material and the waveguide plate bears permanent magnets or is a permanent magnet.

9. Reconfigurable-surface device according to claim 2, wherein the bistable holding means are mechanical.

10. Reconfigurable-surface device according to claims 5, wherein the holding means are electrostatic, at least the second should forming an electrode and the plate bearing the reconfigurable surface forms an electrode.

11. Reconfigurable-surface device according to claim 1, wherein said at least one actuator is capable of generating bending waves or Lamb waves in the waveguide plate.

12. Reconfigurable-surface device according to claim 1, including several actuators distributed on the edges of the waveguide plate.

13. Tactile display includes a reconfigurable-surface device according to claim 1, wherein the reconfigurable surface is a tactile display surface and the device includes a plurality of pins.

14. Tactile display according to claim 13, wherein the pins, when they are in their second position, do not protrude from the display surface, said display forming a Braille display.

15. Tactile display method on the tactile display according to claim 13, including several pins, said method including:
selecting pins to switch from the first position to the second position or vice versa, based on a digital content to be displayed,
sending at least one order to said at least one actuator to change the position of the selected pins,
generating by the at least one actuator waves focused in the waveguide plate at the selected pins, said focusing being obtained with the time-reversal focusing method.
